(19) United States
(12) Patent Application Publication
(10) Pub. No.: US 2003/0135827 A1
(43) Pub. Date: Jul. 17, 2003

(54) System, method and apparatus for improved business intelligence

(76) Inventors: James Kanzler, Babylon, NY (US); Claude Regis, Mt. Vernon, NY (US); Robert G. Schaffrath, Glen Head, NY (US); Lee M. Davidson, San Jose, CA (US); Steven B. Lienhard, Santa Cruz, CA (US)

Correspondence Address: Thomas A. O'Rourke, Bodner & O'Rourke, 425 Broadhollow Road, Melville, NY, 11747, US

(21) Appl. No.: 10/262,638

(22) Filed: Oct. 1, 2002

Related U.S. Application Data
(60) Provisional application No. 60/326,244, filed on Oct. 1, 2001.

(51) Int. Cl. G06F 15/00

(52) U.S. Cl. 715/522; 715/506; 715/505

(57) ABSTRACT

The present invention is directed to a method, system and apparatus for creating reports. In this invention one or more corporate data sources are accessed using one or more data formats. Information from the data sources are combined to form a report.

The present application claims priority on provisional patent aplication 60/326,244 filed Oct. 10, 2001, te disclosures of which are incorporated herein by reference.

### FIELD OF THE INVENTION

The present invention is directed to an improved business tool that allows users to create reports that can access multiple corporate data sources that may use different data formats.

### SUMMARY OF THE INVENTION

The present invention is directed to an improved business intelligence tool that allows users to visually create reports that can access multiple corporate data sources. Each data source that is accessed may be in the same file format as each of the other data sources. In a preferred embodiment, each of the selected data sources may in one or more different file formats. Thus in accordance with the present invention a company can combine in a single report data taken from a plurality of sources. Each of these sources may have file formats which may or may not be compatible with the format of the other data sources. The present invention also provides a portal to a company's critical business information, and permits the user to deliver the generated report results to any one or more devices including but not limited to the Web, Lotus Notes or PDA devices, etc. The present invention can be used with many standard off the shelf programs including but not limited to MS Outlook, MS Excel, MS Word, Lotus Notes, Lotus 123, Brio Query, and others. The present invention is also compatible with Business Objects, and Function Xformer (string support). The system has a PC directory that supports long file names and permits the backup of capsules. For ease of use the desktop of the present invention is a MS Windows type desktop and fully a Windows operating system. The is multi processor support and a Install Shield installer. The system also employs an improved OBDC UBD Gateway (Access, SQL Server, etc.). There is scheduled backup and support for dynamic IP's. Support is also present for PDA, Wap and Cell Phones. There is also a MQ Series Adapter a JSP/ASP Interface. Other features include a D/E Icon to Web Wizard and a Web Interface.

Smart or Proactive Applications

Everyone in the data business understands and recognizes that the amount of data generated or used in today's business is growing exponentially. In fact, it will be appreciated that virtually everyone in an organization will be required to monitor increasing amounts of information with the responsibility to act on that information expeditiously. However, there has been a shift in the way businesses are addressing this problem. Instead of building applications that require human interaction drill down OLAP or ROLAP answers, “smart” applications are emerging as the norm. Smart applications are applications that will query, test and probe the data automatically based on business rule metadata that is define. These business rules might be as simple as “If any of my products' volume falls by more than 10% from the prior period, I want the business manager to be paged and a more detailed report waiting in his e-mail for his review.” Being able to create, define and implement applications of this nature will give businesses a distinct advantage and the ability to react to business issues promptly.

Integration of Data and Applications

Companies are investing significant amounts of funds towards integrating their data and applications to be shared on common platforms. However, while this is a desired result most companies are unable to generate a completely integrated system or data warehouse. The reason is that it is difficult to change a current system that has been used for any period of time. Once the users have become used to a system to retrain them on a new system is expensive, time consuming and frequently meets with employee resistance. As businesses continue to grow and change, it is imperative that companies have development tools that can react to business questions before the data is integrated into their systems. Businesses frequently add new data sources that when added are not ready for systems integration. The present invention permits the integration of data and applications before the data is incorporated into a company's system and this permits the user to achieve the quickest “Time to Answer”to crucial questions. The present invention permits a company an ability to react quickly to very important requests for data or other information over different data formats from no matter what the source. Thus, the data formats may be internal or external business intelligence. These resolutions of these questions can be achieved promptly without having to wait until the data is in a format that is acceptable to the current formats. The present invention provides the ability to integrate data and applications expeditiously.

Web Enabled Analytical Applications

After the completion of analytical applications, it is important to consider as to how one disseminates or distributes those applications or finished reports. The user of the data in a company may wish to disseminate that data externally to clients customers and others who also use different data formats. Many of these data consumers do not have the desire or need to interface with a sophisticated analytical application in order to see their results. Instead, they prefer to have some simple point and click interface to get to the data of importance to them. The Web seems to be the most common and accepted interface portal. Therefore, publishing finished applications and reports to the Web is a necessary and valuable component of the business intelligence system of the present invention The present invention also creates a relationship between a company's business intelligence tool and the delivery mechanism of the Web. Without this relationship, reports will be duplicated in multiple delivery systems to address the needs of data consumers at varying degrees of sophistication.

Ability to Create Local Joins at the Application Level

The ability of the present invention to create local joins at the application level allows the user to combine data from disparate sources or separate queries from within a given database or databases. It is a common need to join data at the application level to:

1) Build business rule comparisons

2) Enhance query performance

3) Join locally created data i.e. local spreadsheet with your database

4) Join data from multiple databases or data sources

5) Calculate aggregates on the fly based on a realignment of data due to new business rules that are in place before the actual data warehouse changes can be implemented. Each of these features can be accomplished by the present invention. It has been found that these tasks are now commonly attempted by manually sorting data and creating joins using spreadsheet macros or writing complex C or Visual Basic code which can be very time consuming and requires an extra level of computer expertise.

Automated Report Refreshes with New Data (Automatic Cutting and Pasting of Data)

Many “canned” reports are created for reuse when new data is posted. This process can be automated to reduce the time necessary to perform these tasks over and over during each data refresh period. With the use of spreadsheet templates and the ability to automate cutting and pasting, a very complicated analysis that is performed on a repetitive basis can be reduced to a single push of a button. Without this functionality, repetitive tasks can introduce errors and can become quite time consuming to the point where full-time employee positions are required just to maintain standardized reports.

Metadata to Define User Friendly Representation of Databases and Their Relationship with Each Other

Metadata eliminates the need for users to guess what their database tables mean. Tables can be named, as the business needs to see them, through a logical representation called metadata. This shields users from unfriendly database naming conventions without effecting underlying systems. Insignificant columns that are confusing to users can also be removed from the users' representation without the need to alter underlying physical tables.

Logical groupings of tables may also be defined in metadata. These grouping can assist the user in determining which tables actually have meaningful relationships with each another. These groupings can also contain the proper joins necessary to create a correct query. Without the use of metadata it is common to see frustrated users unwilling to use the database because too much technical know-how is required. Default joins provided in the metadata also improve the quality of database usage by eliminating “bad” or “runaway” queries, and thereby increasing database credibility and confidence.

Sending Data Directly to Excel and Other Standard Commercial Computer Programs

Seamless integration with Excel is a preferred requirement of business intelligence tools. The present invention accomplishes this integratrion. Integration with Excel does not mean, the method merely creates Excel outputs. It means that the functionality that exists in Excel can be leveraged in a business intelligence application development environment. Leveraging Excel helps mitigate the learning curve that users have when trying to create complicated analysis. A typical benefit of the present invention is the ability to have applications simply drop data into Excel templates and produce complicated reports with little technical effort. This leverages the base knowledge that already exists with a tool that users are comfortable with.

### BRIEF DESCRIPTION OF THE DRAWINGS

FIG. 1 is an example of the architecture of the present invention.

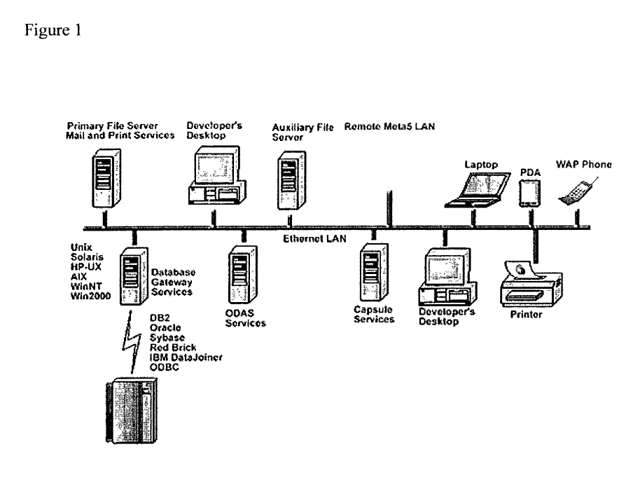

FIG. 2 is a table of key features of the present invention.

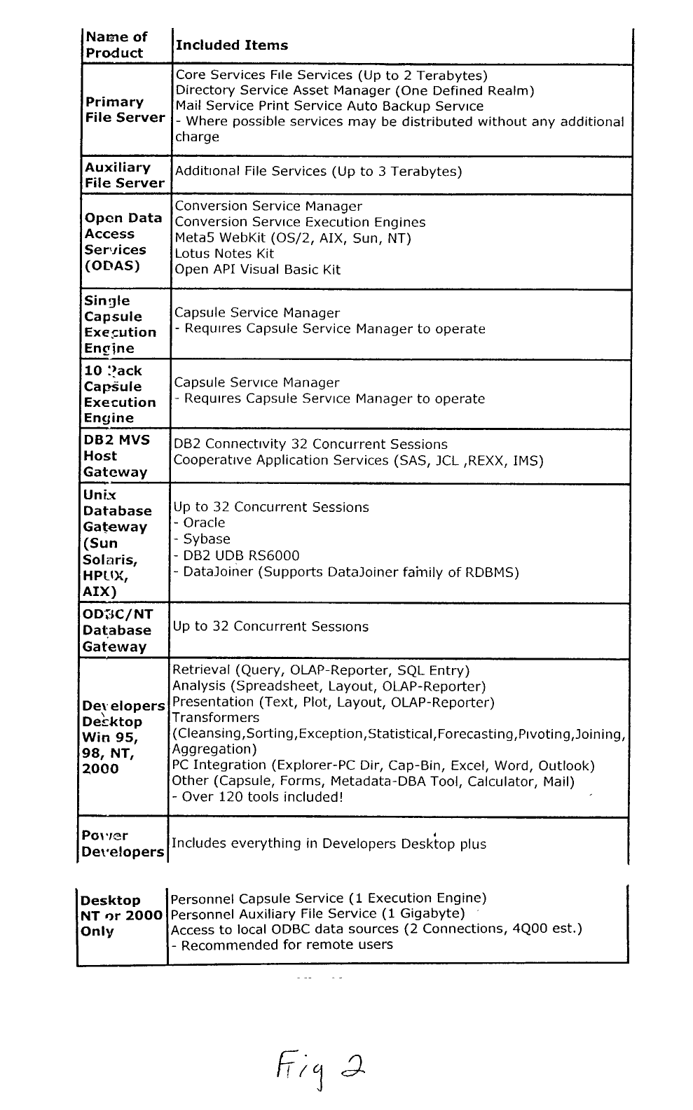

### DETAILED DESCRIPTION OF THE PRESENT INVENTION

The present invention is a system, method and apparatus that incorporates a Primary File Server Core Services File Services that preferably has up to 2 Terabytes of storage or more. This primary file server provides for example, mail and print services in addition to its other abilities. In this example, there is also Directory Service Asset Manager (One or more Defined Realms) as well as Mail Service, Print Service and Auto Backup Service. Preferably, there is also an Auxiliary File Server that preferably provides additional file services (up to 3 Terabytes or more).

The system also preferably has an Open Data Access Services (ODAS) that contains one or more of the following: a Conversion Service Manager, Conversion Service Execution Engines, a WebKit (OS/2, AIX, Sun, NT), a Lotus Notes Kit, and an Open API Visual Basic Kit. Each ODAS preferably also has a Single Capsule Execution Engine and a Capsule Service Manager.

Additional feature of the system of the present invention are as follows:

| | |
|---|---|
| DB2 MVS Host Gateway DB2 Conn- | 32 Concurrent Sessions |
| ectivity | Cooperative Application Services |
| | (SAS, JCL, REXX, IMS) |
| Unix Database Gateway (Sun Solaris, | Up to 32 Concurrent Sessions |
| HPUX, AIX) | Oracle |
| | Sybase |
| | DB2 UDB RS6000 |
| | DataJoiner (Supports DataJoiner |
| | family of RDBMS) |
| ODBC/NT Database Gateway Up to | |
| 32 Concurrent Sessions | |
| Developers Desktop Win 95, 98, NT, | 2000 Retrieval (Query, OLAP-Re- |
| | porter, SQL Entry) |
| | Analysis (Spreadsheet, Layout, |
| | OLAP-Reporter) |
| | Presentation (Text, Plot, Layout, |
| | OLAP-Reporter) |
| | Transformers |
| | (Cleansing, Sorting, Exception, |
| | Statistical, Forecasting, |
| | Pivoting. Joining, Aggregation) |
| | PC Integration (Explorer-PC Dir, |
| | Cap-Bin, Excel, Word, Outlook) |
| | Other (Capsule, Forms, Metadata- |
| | DBA Tool, Calculator, Mail) |
| | Over 120 tools included! |
| Power Developers Desktop NT or | Includes everything in Developers |
| 2000 Only | Desktop plus |
| | Personnel Capsule Service (1 Ex- |
| | ecution Engine) |
| | Personnel Auxiliary File Service (1 |
| | Gigabyte) |
| | Access to local ODBC data sources |
| | (2 Connections, 4Q00 est.) |

Recommended for remote users

The present invention has a multi-tier architecture designed to support a wide range of clients for applications that demand intensive, multidimensional data analysis. It delivers advanced analyses and decision support directly to your existing end-user software environments. With the present invention, decision making is easier, more productive, cost-effective and much more scalable than traditional decision support systems (DSS) and on-line analytical processing (OLAP) solutions.

The present invention provides a visual reporting environment that integrates data and applications across a corporate enterprise. With this unique functionality, the system can quickly solve the most complicated business intelligence problems that require the majority of a business' development time. The highlights include:

A Visual Object Programming Environment that allows users to perform complicated analysis by connecting visual objects together without writing programming code.

The ability to query, extract and join data at the application level from relational, star schema, non-relational, ASCII, and spreadsheet data sources.

A 120 tool, feature-rich product that can be leveraged to incorporate other Windows-based tools, including Excel, Word and Outlook, allowing you to create the most comprehensive application development environment in the industry.

A fully-scalable, multi-tier architecture that accommodates the largest of corporate deployments. This architecture makes us the perfect application engine for your corporate portal, web-based or light-client solution.

The present invention has applicability in many fields, including but not limited to:

Transportation service

Distribution

Consumer Retail

Consumer Products

Business Products

Commodity Products

Aerospace

Communications

Insurance

Health Care

Pharmaceutical

Financial services

Additional aspects of the present invention are set forth in the attached Appendix A1-A22.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A method of creating reports comprising
a) accessing one or more corporate data sources using one or more data formats;
b) combining the information from said data sources to form a report.

2. The method according to claim 1 wherein at least two data source are in a different data format.

3. The method according to claim 1 further comprising the step of providing a portal to a company's critical business information.

4. The method according to claim 3 further comprising permiting the user to deliver the generated report results to any one or more devices.

5. The method according to claim 4 wherein the device is the Web.

6. The method according to claim 4 wherein the device is Lotus Notes

7. The method according to claim 4 wherein the device is a PDA.

8. The method according to claim 2 wherein the data formats comprise one or more of MS Outlook, MS Excel, MS Word, Lotus Notes, Lotus 123, and Brio Query.

9. The method according to claim 2 further comprising the steps of making a query, testing the query and probing the data automatically based on a business rule metadata that is defined.

10. A method for creating an improved business intelligence tool comprising the steps of:
providing data from one or more sources and providing one or more applications for manipulating said data;
integrating said data and said application before the data is incorporated into a company's computer system;
combining said data in a single report.

11. The method according to claim 10 further comprising the step of providing a portal to the company's critical business information.

12. The method according to claim 11 further comprising the step of delivering report results to any one or more devices.

13. An apparatus for an improved business intelligence tool comprising:
a primary file server;
a means for providing data from one or more sources and a means for providing one or more applications for manipulating said data;
a means for integrating said data and said application before the data is incorporated into a company's computer system;
a means for combining said data in a single report.

14. An apparatus for an improved business intelligence tool comprising:
a directory service asset manager;
an auxiliary file server providing additional file services;
a means for providing data from one or more sources and a means for providing one or more applications for manipulating said data;
a means for integrating said data and said application before the data is incorporated into a company's computer system;
a means for combining said data in a single report.

15. An apparatus for an improved business intelligence tool comprising:
an open data access service, said open data access service consisting of a conversion service manager, a conversion service execution engine;
said open data access service having either a single capsule execution or a capsule service manager.

16. A system for an improved business intelligence tool comprising:
a visual object programming environment that allows users to perform complicated analysis by connecting visual objects together without writing programming code;
an ability to query, extract and join data at the application level form relational, star schema, non-relational, ASCIL, and spreadsheet data sources;
a tool system that can incorporate one or more software tools;
a fully-scalable, multi-tier architecture.
